(19) United States
(12) Patent Application Publication
(10) Pub. No.: US 2015/0375639 A1
(43) Pub. Date: Dec. 31, 2015

(54) ROTATABLE VEHICLE SEAT FRAME AND A ROTATABLE VEHICLE SEAT FRAME ASSEMBLY

(71) Applicant: WAN-YU LI, (US)

(72) Inventors: QING-KUN YIN, GUANGDONG (CN); CHIN-CHEN CHANG, TAIPEI CITY (TW)

(21) Appl. No.: 14/497,559

(22) Filed: Sep. 26, 2014

(30) Foreign Application Priority Data
Jun. 26, 2014 (CN) 201410288786.1

(51) Int. Cl. B60N 2/14; B60N 2/07; B60N 3/00; B60N 2/22; B60N 2/02; A47B 83/02; B60N 2/20

(52) U.S. Cl. CPC B60N 2/14; A47B 83/02; B60N 2/0722; B60N 2/0732; B60N 2/20; B60N 2/2213; B60N 2/0232; B60N 3/001; B60N 2002/024

(57) ABSTRACT

A rotatable vehicle seat frame has a base bracket, a stand, a seat bracket and a back support bracket in sequence from up to down. A bottom sliding mechanism is mounted between the base bracket and the stand. A top sliding mechanism is mounted between the stand and the seat bracket. An angle-adjusting mechanism is mounted between the seat bracket and the back support bracket. The mechanisms mentioned above enable the rotatable vehicle seat frame to be rotated and transformed between a passenger-mode and a cargo-mode. Multiple rotatable vehicle seat frames with a frame and an elevatable desk form a rotatable vehicle seat frame assembly to be further applied in various kinds of vehicles.

### CROSS-REFERENCE TO RELATED APPLICATIONS

This application is based upon and claims priority under 35 U.S.C. 119 from China Patent Application No. 201410288786.1 filed on Jun. 26, 2014, which is hereby specifically incorporated herein by this reference thereto.

### BACKGROUND OF THE INVENTION

1. Field of the Invention

The present invention relates to a rotatable vehicle seat frame and a rotatable vehicle seat frame assembly, especially to a rotatable vehicle seat frame that can be installed in a vehicle for a user to be seated on.

2. Description of the Prior Arts

Vehicles generally include the following two types: the type designed for passengers and the type designed for cargo. Vehicles designed for passengers often have fixed vehicle seats in the back seat area for passengers, and have a relatively narrower accommodating space behind the fixed vehicle seats, which is for accommodating goods in small quantity or volume. Vehicles designed for cargo have no back seats in the back seat area and have a relatively larger accommodating space instead for accommodating goods in large quantity or volume.

However, users may need one vehicle with different functions for different situations. For example, the user may need a vehicle designed for cargo when working, but also need a vehicle designed for passengers when going out with family or friends. If the user takes passengers on a vehicle designed for cargo, it is dangerous and uncomfortable for the passengers as the vehicle has no fixed passenger seats to sit on. If the user loads cargo on a vehicle designed for passengers, the vehicle cannot accommodate goods in large quantity or volume as the fixed vehicle seats occupy most central parts of the back seat area. As a result, for those who have both needs as mentioned above, the conventional vehicles are quite inconvenient.

To overcome the shortcomings, the present invention provides a rotatable vehicle seat frame and a rotatable vehicle seat frame assembly to mitigate or obviate the aforementioned problems.

### SUMMARY OF THE INVENTION

The main objective of the present invention is to provide a rotatable vehicle seat frame and a rotatable vehicle seat frame assembly, wherein the rotatable vehicle seat frame can be transformed between a passenger-mode and a cargo-mode to facilitate convenience and applicability.

The rotatable vehicle seat frame has a stand assembly, a seat assembly and a back support assembly. The stand assembly has a base bracket, a stand and a bottom sliding mechanism. The bottom sliding mechanism is mounted between the base bracket and the stand to make the stand slidable relative to the base bracket. The seat assembly is slidably mounted on a top surface of the stand assembly, and has a seat bracket and a top sliding mechanism. The top sliding mechanism is mounted between the seat bracket and the stand to make the seat bracket slidable relative to the stand. The back support assembly is pivotally connected to the seat assembly, and has a back support bracket and at least one angle-adjusting mechanism. The at least one angle-adjusting mechanism is mounted between the back support bracket and the seat bracket to make the back support bracket rotatable relative to the seat bracket.

The bottom sliding mechanism, the top sliding mechanism and the angle-adjusting mechanism enable the seat frame to be rotated into a flattened status in a limited inner space of a vehicle, and enable the seat frame to be transformed between a passenger-mode and a cargo-mode. When in the passenger-mode, the position of the seat bracket and the angle of the back support bracket may be adjusted to facilitate convenience.

The rotatable vehicle seat frame assembly has a main frame, multiple rotatable vehicle seat frames as mentioned above, and at least one elevatable desk. The stand assembly of each rotatable vehicle seat frame is mounted on the main frame. Each elevatable desk is retractably mounted in the main frame.

The varieties in use of the seat frame mentioned above with the elevating or retracting of the elevatable desk enable the seat frame assembly to provide the user with more use modes in a limited space.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a rotatable vehicle seat frame in accordance with the present invention;

FIG. 2 is an exploded perspective view of the rotatable vehicle seat frame in FIG. 1;

FIG. 3 is an enlarged partial perspective view of the rotatable vehicle seat frame in FIG. 1;

FIG. 4 is another enlarged partial perspective view of FIG. 3;

FIG. 5 is an enlarged partial perspective view of the rotatable vehicle seat frame in FIG. 1;

FIG. 6 is a perspective view of an angle-adjusting mechanism of the rotatable vehicle seat frame in FIG. 1;

FIG. 7 is another perspective view of FIG. 6;

FIGS. 8 to 11 are operational side views of the rotatable vehicle seat frame in FIG. 1;

FIG. 12 is a perspective view of a second embodiment of a rotatable vehicle seat frame in accordance with the present invention;

FIG. 13 is a perspective view of a third embodiment of a rotatable vehicle seat frame in accordance with the present invention;

FIG. 14 is a side view of the rotatable vehicle seat frame in FIG. 13;

FIG. 15 is an operational side view of the rotatable vehicle seat frame in FIG. 13;

FIG. 16 is an operational perspective view of the rotatable vehicle seat frame in FIG. 13;

FIG. 17 is another operational side view of the rotatable vehicle seat frame in FIG. 13;

FIG. 18 is another operational perspective view of the rotatable vehicle seat frame in FIG. 13;

FIG. 19 is still another operational side view of the rotatable vehicle seat frame in FIG. 13;

FIG. 20 is a perspective view of a first embodiment of a rotatable vehicle seat frame assembly in accordance with the present invention;

FIG. 21 is a perspective view of an elevatable desk of the rotatable vehicle seat frame in FIG. 1;

FIG. 22 is an operational perspective view of the elevatable desk of the rotatable vehicle seat frame in FIG. 1;

FIG. 23 is another operational perspective view of the elevatable desk of the rotatable vehicle seat frame in FIG. 1;

FIGS. 24 and 25 are operational perspective views of the rotatable vehicle seat frame in FIG. 1; and

FIGS. 26 to 32 are operational perspective views of a second embodiment of a rotatable vehicle seat frame assembly in accordance with the present invention.

### DETAILED DESCRIPTION OF THE PREFERRED EMBODIMENTS

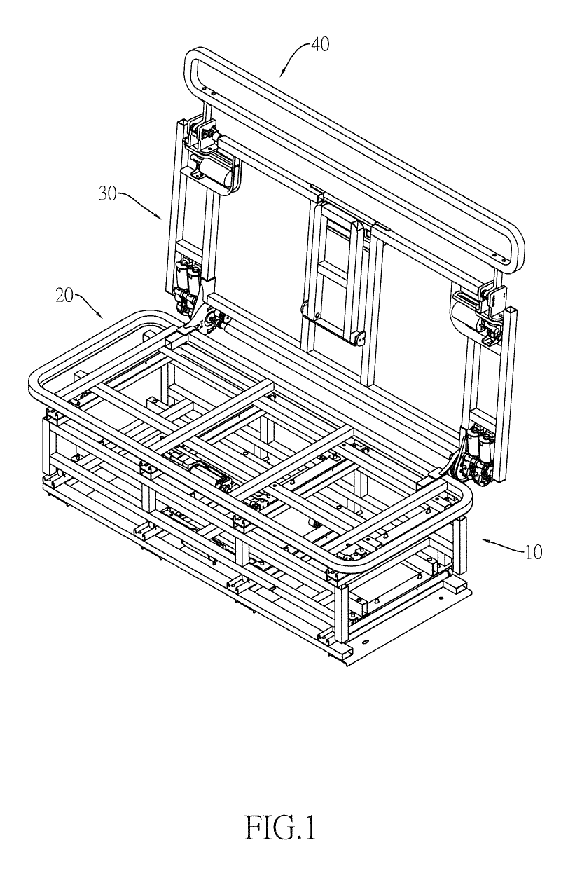

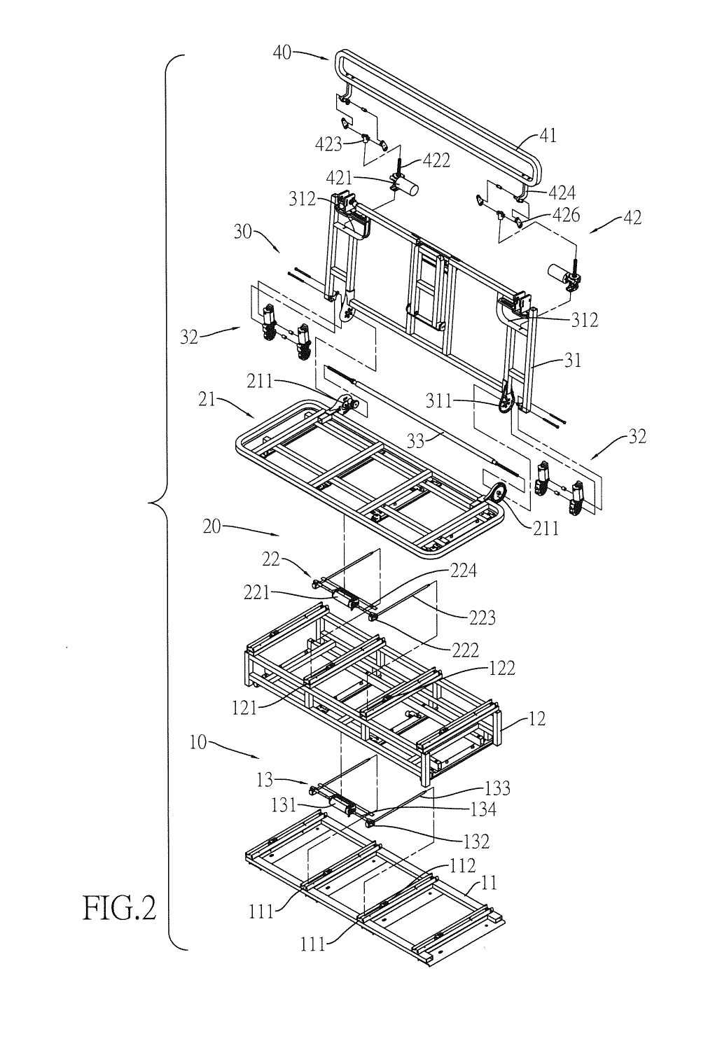

With reference to FIGS. 1 and 2, a first embodiment of a rotatable vehicle seat frame in accordance with the present invention comprises a stand assembly 10, a seat assembly 20, a back support assembly 30 and a headrest assembly 40.

The stand assembly 10 has a base bracket 11, a stand 12 and a bottom sliding mechanism 13. The stand 12 is slidably mounted on a top surface of the base bracket 11. The bottom sliding mechanism 13 is mounted between the base bracket 11 and the stand 12 to make the stand 12 slidable relative to the base bracket 11. In a preferred embodiment, the stand assembly 10 further has at least one first channel assembly mounted on the top surface of the base bracket 11, and each one of the at least one first channel assembly has a channel 111 and a nut 112. The channel 111 is disposed on the top surface of the base bracket 11. The nut 112 is mounted in the channel 111. The bottom sliding mechanism 13 is mounted on a bottom surface of the stand 12, and has at least one gear assembly 132, a motor 131 and at least one threaded rod 133. The motor 131 is mounted securely on the bottom surface of the stand 12, and has at least one drive shaft 134. The at least one drive shaft 134 protrudes out of an end of the motor 131, and is mounted in the at least one gear assembly 132. Each one of the at least one threaded rod 133 has a first end and a second end. The first end is screwed into the corresponding gear assembly 132. The second end is screwed into the nut 112 of the corresponding first channel assembly. When the motor 131 is switched on, each drive shaft 134 rotates the corresponding threaded rod 133 via the corresponding gear assembly 132. The rotating of the threaded rod 133 relative to the nut 112 makes the threaded rod 133 move axially relative to the nut 112, such that the stand 12, which is fixed with the bottom sliding mechanism 13, moves relative to the base bracket 11 as well. Preferably, the motor 131 is disposed in a center of the stand 12 and has two drive shafts 134. The two drive shafts 134 respectively protrude out of two ends of the motor 131, and respectively actuate multiple gear assemblies 132 with multiple threaded rods 133 on both sides of the motor 131. The stand assembly 10 has multiple first channel assemblies arranged apart from each other.

The seat assembly 20 is slidably mounted on a top surface of the stand assembly 10, and has a seat bracket 21 and a top sliding mechanism 22. The top sliding mechanism 22 is mounted between the seat bracket 21 and the stand 12 to make the seat bracket 21 slidable relative to the stand 12. In a preferred embodiment, the stand assembly 20 further has at least one second channel assembly. Each one of the at least one second channel assembly is mounted on a top surface of the stand 12, and has a channel 121 and a nut 122. The channel 121 is disposed on the top surface of the stand 12. The nut 122 is mounted in the channel 121. The top sliding mechanism 22 is mounted on a bottom surface of the seat bracket 21, and has at least one gear assembly 222, a motor 221, and at least one threaded rod 223. The motor 221 is mounted securely on the bottom surface of the seat bracket 21, and has at least one drive shaft 224. The at least one drive shaft 224 protrudes out of an end of the motor 221, and is mounted in the at least one gear assembly 222. Each one of the at least one threaded rod 223 has a first end and a second end. The first end is screwed into the corresponding gear assembly 222. The second end is screwed into the nut 122 of the corresponding second channel assembly. When the motor 221 is switched on, each drive shaft 224 rotates the corresponding threaded rod 223 via the corresponding gear assembly 222. The rotating of the threaded rod 223 relative to the nut 122 makes the threaded rod 223 move axially relative to the nut 122, such that the seat bracket 21, which is fixed with the top sliding mechanism 22, moves relative to the stand 12 as well. Preferably, the motor 221 is disposed in a center of the seat bracket 21 and has two drive shafts 224. The two drive shafts 224 respectively protrude out of two ends of the motor 221, and respectively actuate multiple gear assemblies 222 with multiple threaded rods 223 on both sides of the motor 221. The stand assembly 10 has multiple second channel assemblies arranged apart from each other.

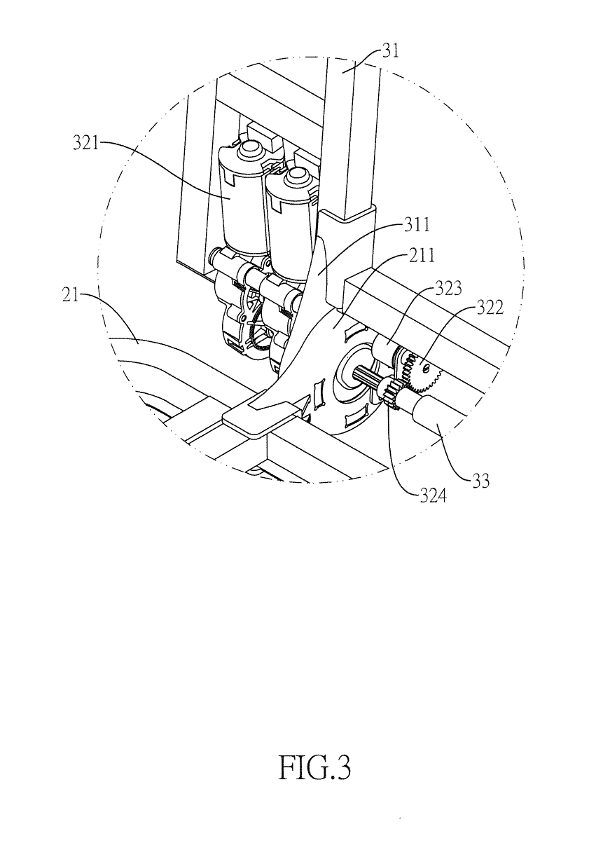

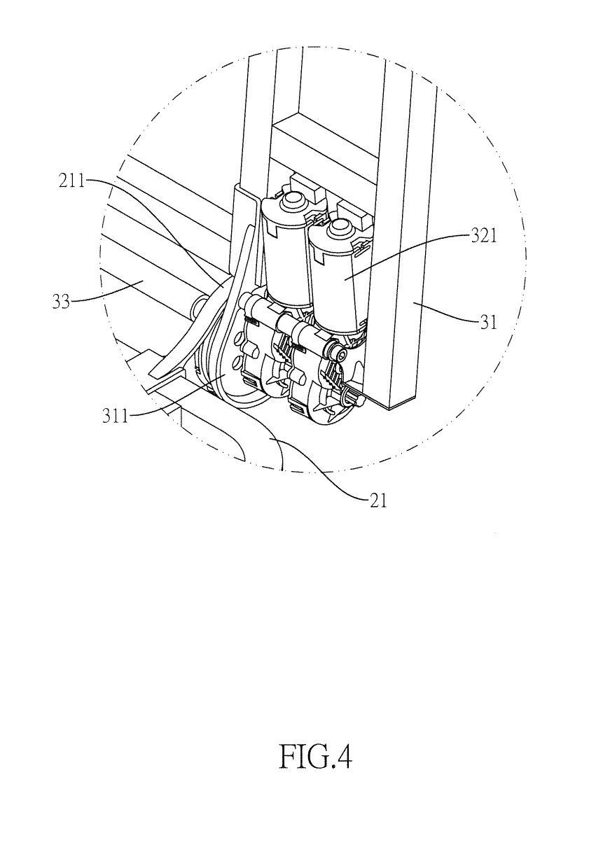

With reference to FIGS. 2 to 4, the back support assembly 30 is pivotally connected to the seat assembly 20, and has a back support bracket 31 and at least one angle-adjusting mechanism 32. The at least one angle-adjusting mechanism 32 is mounted between the back support bracket 31 and the seat bracket 21 to make the back support bracket 31 rotatable to be horizontal relative to the seat bracket 21. In a preferred embodiment, the seat assembly 20 further has at least one pivot seat 211 formed on a back side of the seat bracket 21. The back support assembly 30 further has at least one pivot seat 311 formed on a bottom side of the back support bracket 31. Each of the at least one angle-adjusting mechanism 32 has at least one motor assembly 321. Each motor assembly 321 is mounted securely on the back support bracket 31 and has an output shaft. The output shaft engages with the corresponding pivot seat 211 of the seat assembly 20, such that the output shaft is unrotatable relative to the seat assembly 20. In a preferred embodiment, each angle-adjusting mechanism 32 further has an actuating assembly 323 and a driven gear 322. The actuating assembly 323 is connected to the corresponding pivot seat 211 of the seat assembly 20. The driven gear 322 is connected to the actuating assembly 323. The back support assembly 30 further has a pintle 33 and at least one driving gear 324. The pintle 33 is mounted through the at least one pivot seat 211 of the seat assembly 20 and the at least one pivot seat 311 of the back support assembly 30, and is mounted in and rotated by the motor assembly 321. The at least one driving gear 324 is mounted around the pintle 33, and engages with the driven gear 322 of the corresponding angle-adjusting mechanism 32. When the motor assembly 321 is switched on, the motor assembly 321 rotates the output shaft. Since the output shaft is unrotatable relative to the seat assembly 20, the motor assembly 321 and the back support bracket 31 are rotatable relative to the output shaft and the seat assembly 20. In addition, the pintle 33 is rotated by the motor assembly 321, such that the driving gear 324 rotates the corresponding driven gear 322. The driven gear 322 rotates the actuating assembly 323, such that the actuating assembly 323 controls and adjusts the speed and the angle of the rotating of the back support bracket 31 relative to the seat bracket 21. In a preferred embodiment, the back support assembly 30 has two angle-adjusting mechanisms 32 respectively disposed on two sides of the back support bracket 31. The seat assembly 20 has two pivot seats 211 disposed on two sides of the seat bracket 21, and the back support assembly 30 has two pivot seats 311 disposed on two sides of the back support bracket 31. Each angle-adjusting mechanism 32 has two motor assemblies 321, and both ends of the pintles 33 are respectively mounted into the motor assemblies 321 of the two angle-adjusting mechanisms 32.

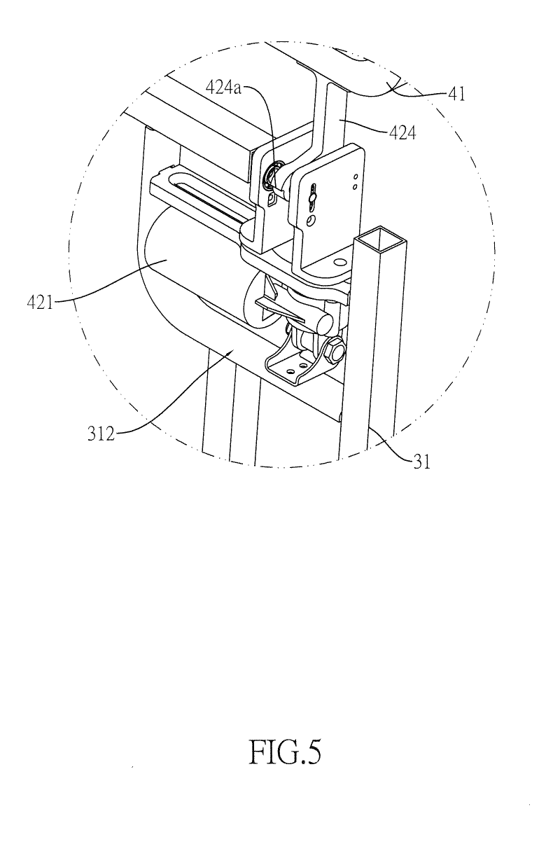

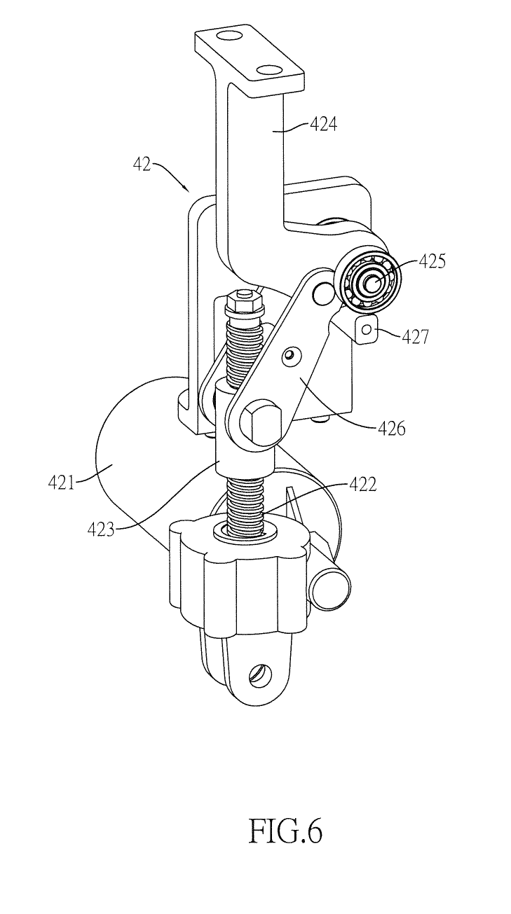

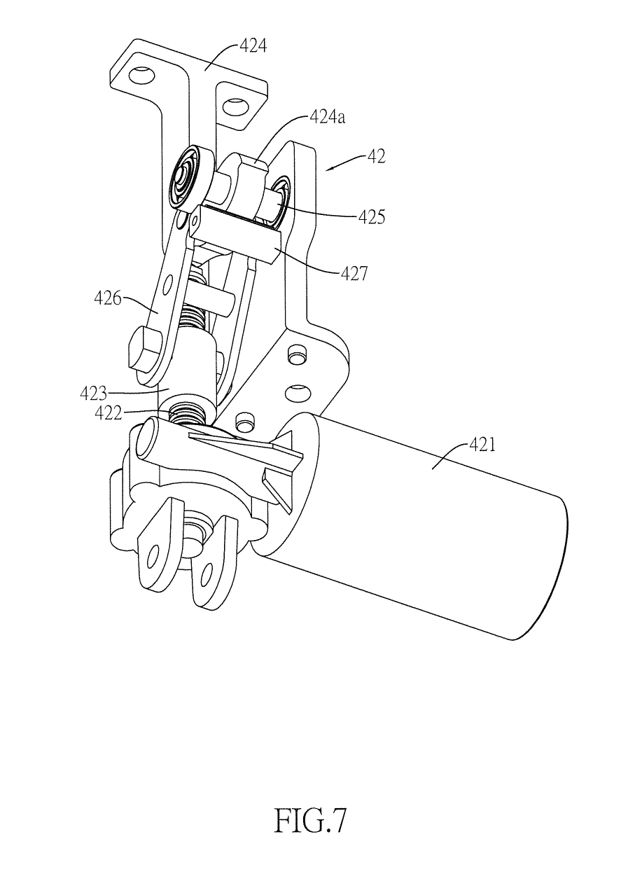

With reference to FIG. 2, the headrest assembly 40 is pivotally connected to the back support assembly 30, and has a headrest bracket 41 and at least one sliding eccentric rod mechanism 42. The at least one sliding eccentric rod mechanism 42 is mounted between the headrest bracket 41 and the back support bracket 31 to make the headrest bracket 41 rotatable relative to the back support bracket 31. With reference to FIGS. 5 to 7, in a preferred embodiment, the back support bracket 31 has at least one recess 312 formed in the back support bracket 31. Each one of the at least one sliding eccentric rod mechanism 42 has a motor assembly 421, a threaded rod 422, a out 423, a swing arm 424, a positioning rotating shaft 425, a connecting arm 426 and a limit pin 427. The motor assembly 421 is mounted in the recess 312 of the back support bracket 31. The threaded rod 422 is rotated by the motor assembly 421. The nut 423 is mounted around the threaded rod 422. The swing arm 424 is mounted securely on a bottom side of the headrest bracket 41, and has a stop protrusion 424a formed on an end of the swing arm 424. The positioning rotating shaft 425 is transversely mounted through and pivotally connected to the swing arm 424. The connecting arm 426 has a first end, a second end and a side. The first end is pivotally connected to the nut 423 of the sliding eccentric rod mechanism 42. The second end is pivotally connected to the swing arm 424. The side of the connecting arm 426 abuts the positioning rotating shaft 425. The limit pin 427 is disposed in a side of the positioning rotating shaft 425. The stop protrusion 424a of the swing arm 424 selectively abuts the limit pin 427. When the motor assembly 421 is switched on, the threaded rod 422 rotates to move the nut 423 axially along the threaded rod 422. At this time, the connecting arm 426 is rotated upward to rotate the swing arm 424 relative to the positioning rotating shaft 425. Consequently, the headrest bracket 41 rotates relative to the back support bracket 31.

The angle and position of the rotatable vehicle seat frame may be adjusted according to the mechanisms mentioned above to meet the demands of user. For example, operating the bottom sliding mechanism 13 to move the stand 12 relative to the base bracket 11, operating the top sliding mechanism 22 to move the seat bracket 21 relative to the stand 12, operating the angle-adjusting mechanism 32 to rotate the back support bracket 31 relative to the seat bracket 21 to adjust the back support bracket 31 to a suitable angle, or operating the sliding rod assembly 42 to rotate the headrest bracket 41 relative to the back support bracket 31 to adjust the headrest bracket 41 to a suitable angle.

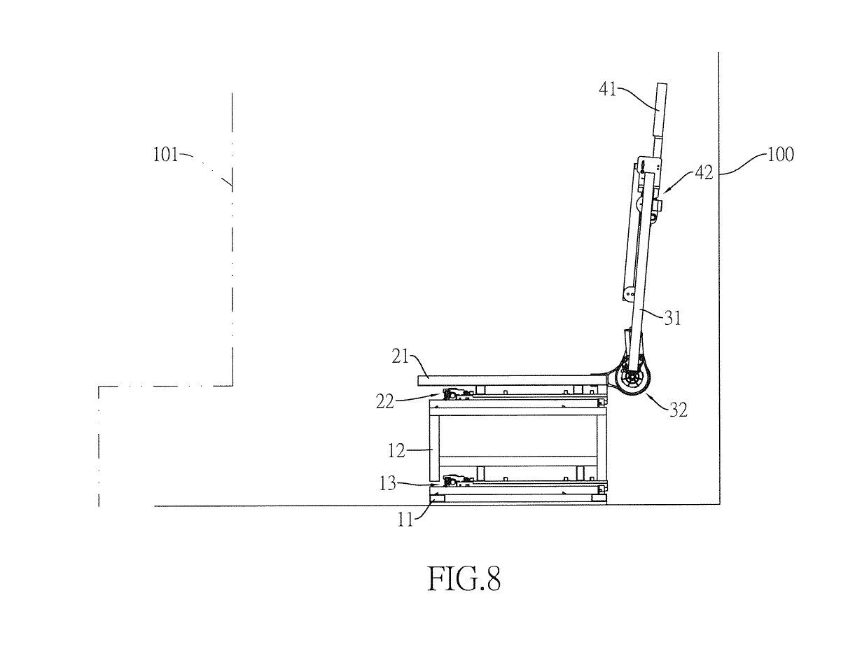

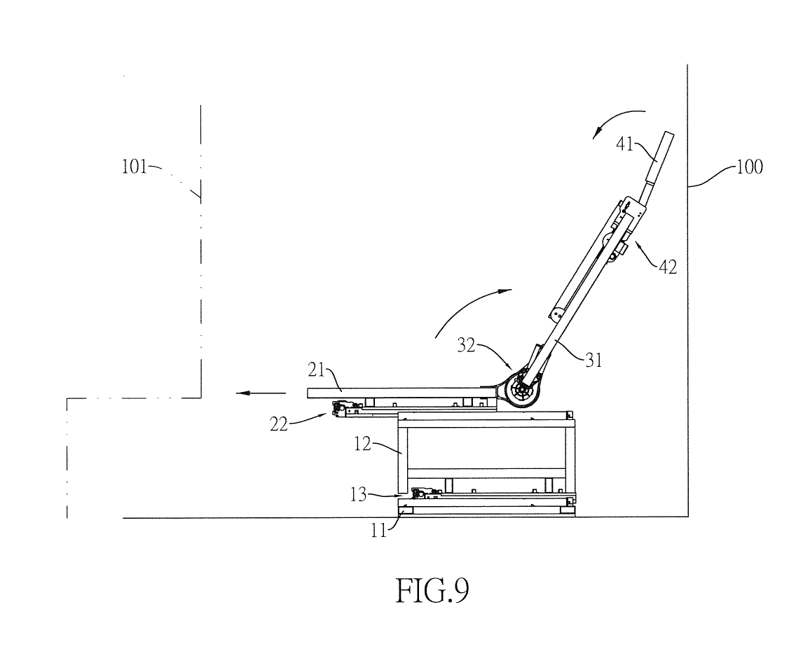

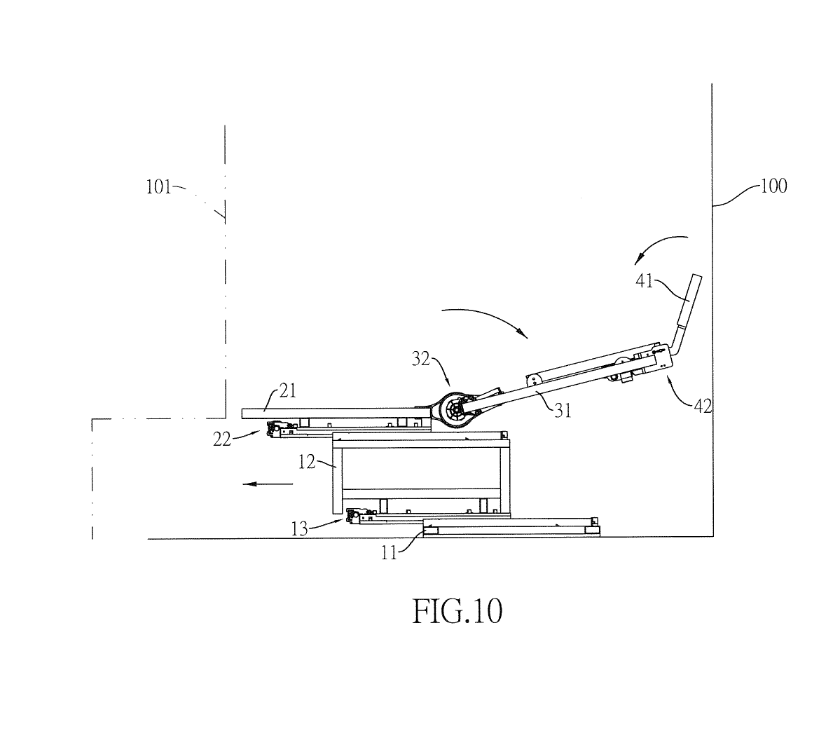

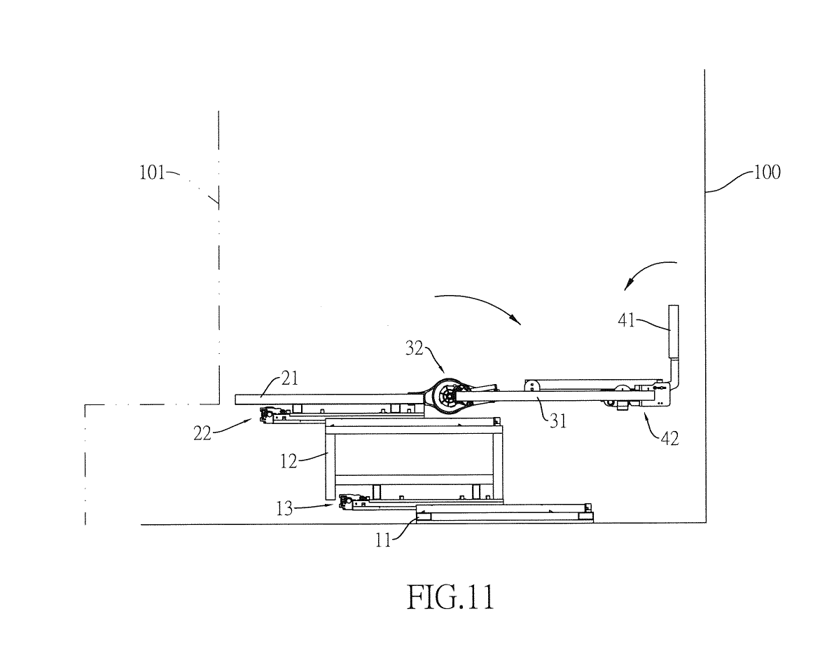

With reference to FIGS. 8 to 11, when the rotatable vehicle seat frame is rotated into a flattened status, the top sliding mechanism 22 is switched on first to move the seat bracket 21 relative to the stand 12, and simultaneously the II angle-adjusting mechanism 32 is switched on to rotate the back support bracket 31. During the movements mentioned above, the headrest bracket 41 and the back support bracket 31 are respectively kept from hitting a rear inner wall 100 of the vehicle and a front row seat 101 of the vehicle. Then the bottom sliding mechanism 13 is switched on to move the stand 12 relative to the base bracket 11, and the sliding eccentric rod mechanism 42 is switched on to rotate the headrest bracket 41. Finally, the seat bracket 21 and the back support bracket 31 are coplanar, and are parallel to a bottom surface of the vehicle to be in the flattened status, which is convenient for loading cargo or for use as a bed.

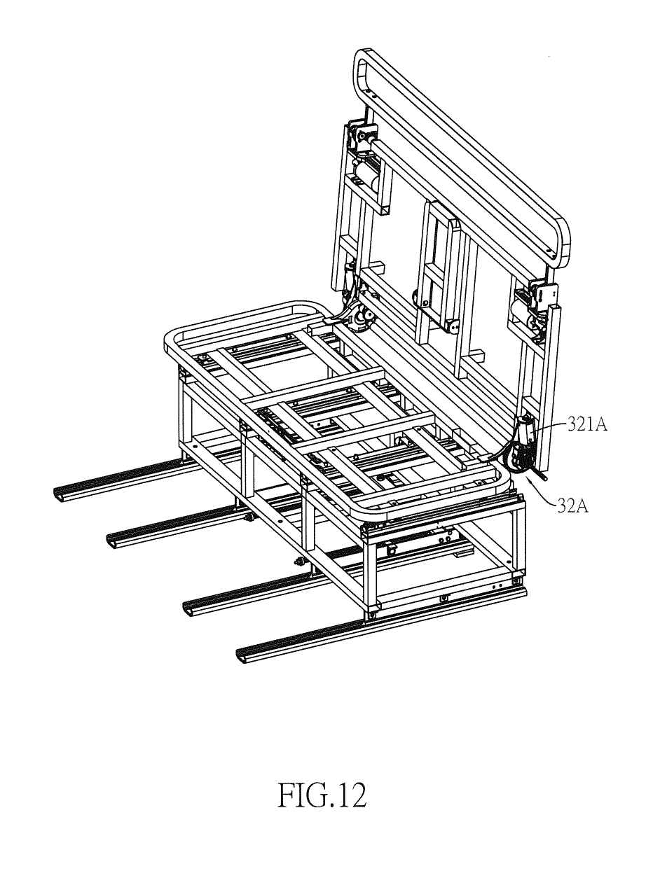

With reference to FIG. 12, a second embodiment of the rotatable vehicle seat frame in accordance with the present invention is substantially similar to the first embodiment mentioned above, and the major difference between the two embodiments is that in the second embodiment, each angle-adjusting mechanism 32A has only one motor assembly 321A.

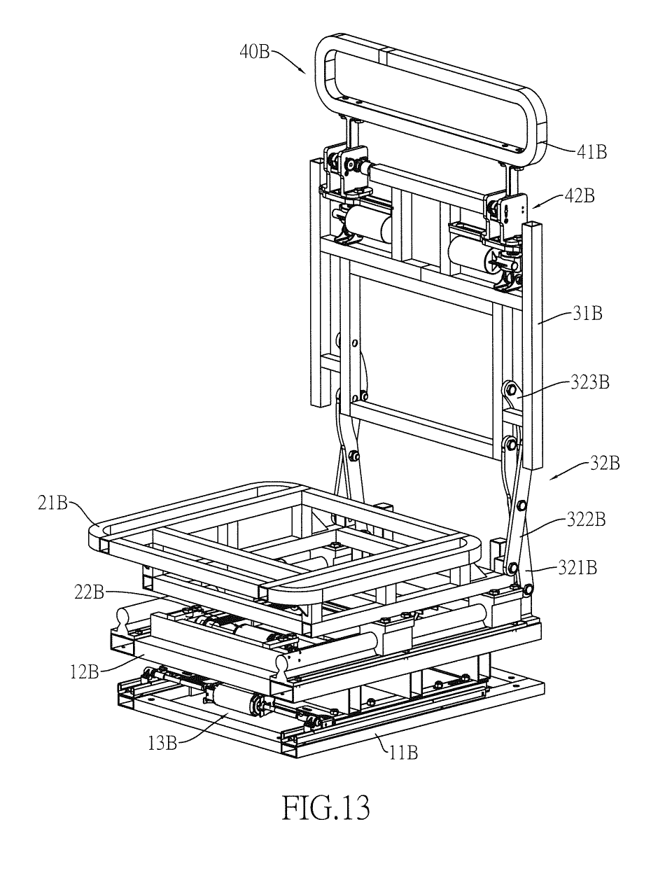

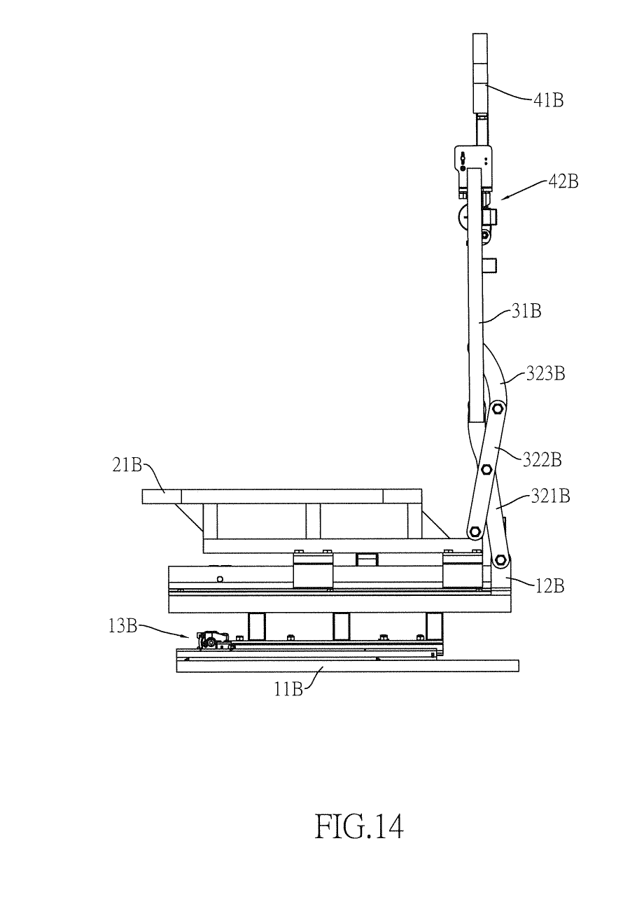

With reference to FIGS. 13 and 14, a third embodiment of the rotatable vehicle seat frame in accordance with the present invention is substantially similar to the first embodiment mentioned above. The basic connections between, and the basic structures of, the base bracket 11B, the stand 12B, the bottom sliding mechanism 13B, the seat bracket 21B, the top sliding mechanism 22B, the back support bracket 31B and the headrest assembly 40B are the same as the first embodiment, but shapes of the components mentioned above are slightly varied. The major difference between the two embodiments is that in the third embodiment, each angle-adjusting mechanism 32B has a first rod 321B, a second rod 322B and a third rod 323B. The first rod 321B, the second rod 322B and the third rod 323B each have a first end and a second end. The first end of the first rod 321B is pivotally connected to the stand 12B. The second end of the first rod 321B is pivotally connected to the back support bracket 31B. The first end of the second rod 322B is pivotally connected to the seat bracket 21B. A center segment of the second rod 322B is pivotally connected to a center segment of the first rod 321B. The first end of the third rod 323B is pivotally connected to the second end of the second rod 322B. The second end of the third rod 323B is pivotally connected to the back support bracket 31B.

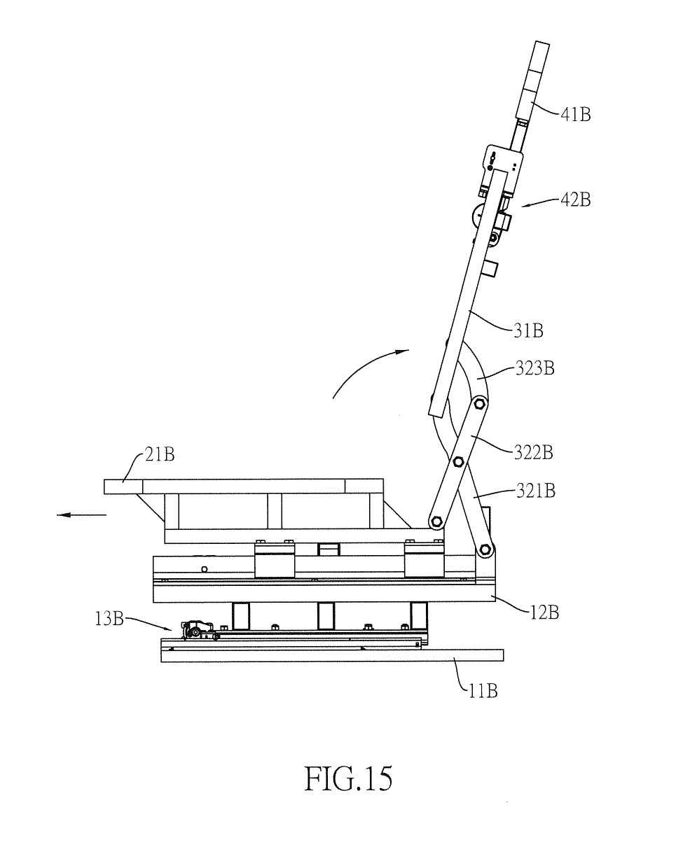

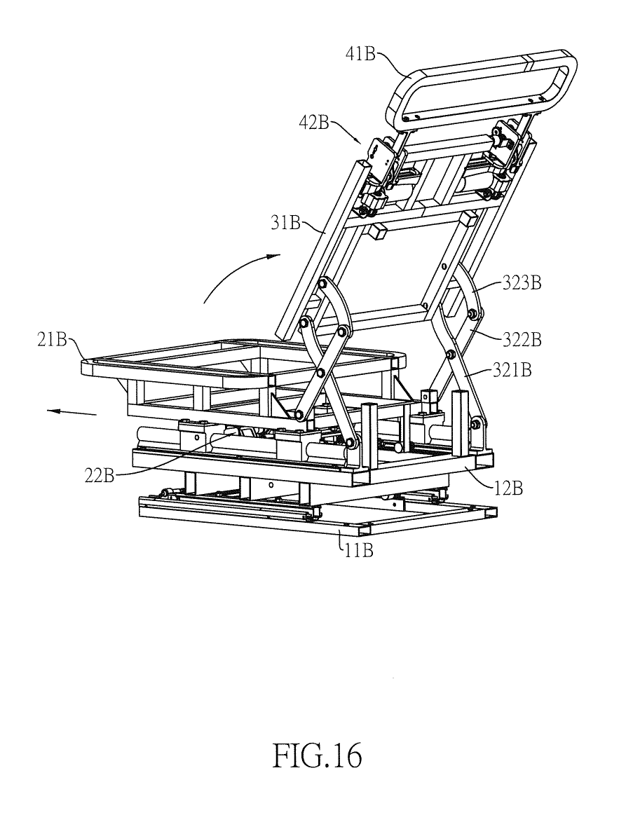

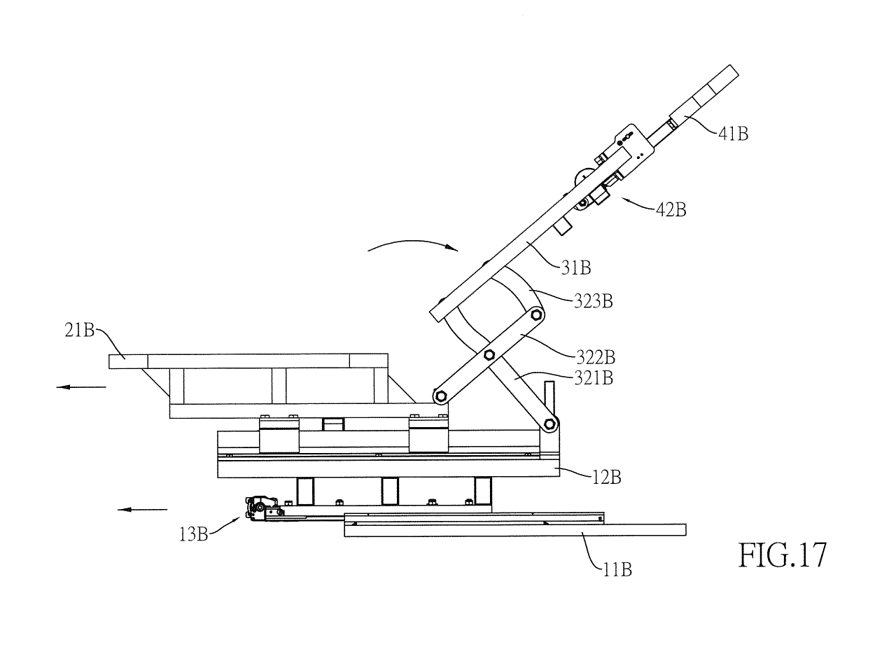

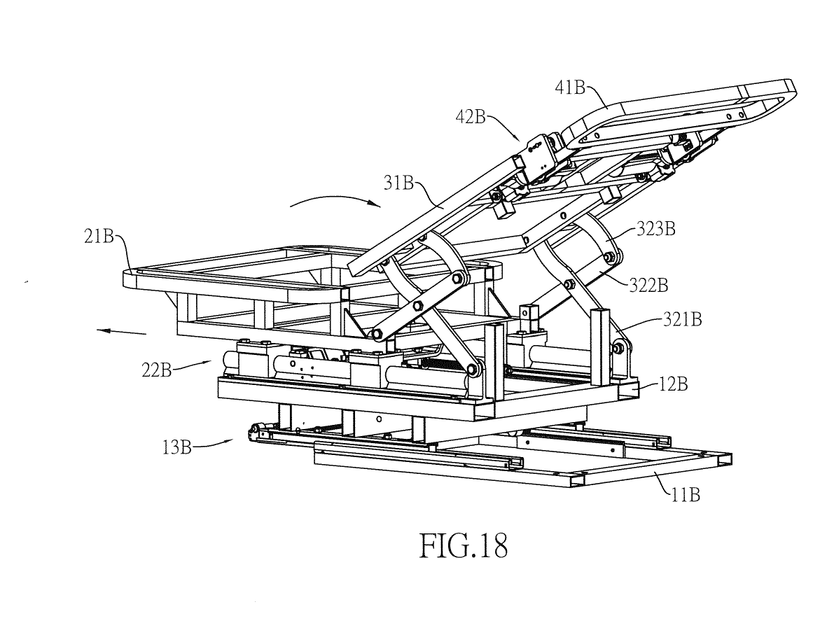

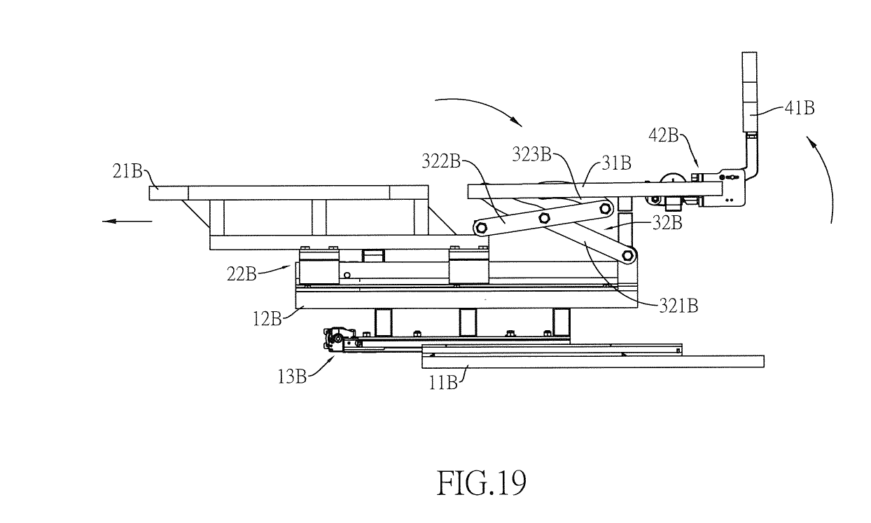

With reference to FIGS. 15 to 19, when the rotatable vehicle seat frame is rotated into the flattened status, the top sliding mechanism 22B is switched on first to move the seat bracket 21B relative to the stand 12B, and simultaneously the second rod 322B rotates relative to the first rod 321B and the third rod 323B to gradually rotate the back support bracket 31B. Or the bottom sliding mechanism 13B is switched on to move the stand 12B relative to the base bracket 11 B, and the sliding eccentric rod mechanism 42B is switched on to gradually rotate the headrest bracket 41B. During the movements mentioned above, the first rod 321B, the second rod 322B and the third rod 3238 are also rotated. Finally, the seat bracket 21B and the back support bracket 31B are coplanar, and are parallel to the bottom surface of the vehicle to be in the flattened status, which is convenient for loading cargo or for use as a bed.

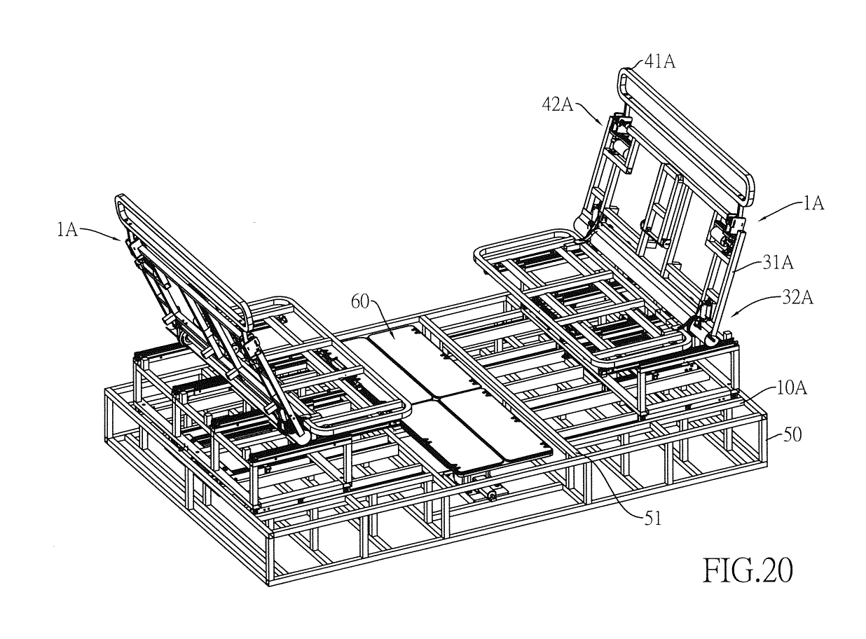

With reference to FIG. 20, a first embodiment of a rotatable vehicle seat frame assembly in accordance with the present invention may be applied in vehicles with bigger inner space such as a nine seater Multi-Purpose Vehicle (MPV), a nine seater Sport Utility Vehicle (SUV), or a tourist bus. The rotatable vehicle seat frame assembly comprises a main frame 50, multiple rotatable vehicle seat frames 1A of the second embodiment mentioned above, and at least one elevatable desk 60. The stand assembly 10A of each rotatable vehicle seat frame 1A is mounted on the main frame 50. The at least one elevatable desk 60 is retractably mounted in the main frame 50. In a preferred embodiment, the rotatable vehicle seat frame assembly has two rotatable vehicle seat frames 1A and two elevatable desks 60. Each rotatable vehicle seat frame IA is for two passengers. The two rotatable vehicle seat frames 1A are disposed on a top surface of the main frame 50, and are disposed opposite to each other. The elevatable desks 60 are disposed between the rotatable vehicle seat frames 1A, and are disposed side by side.

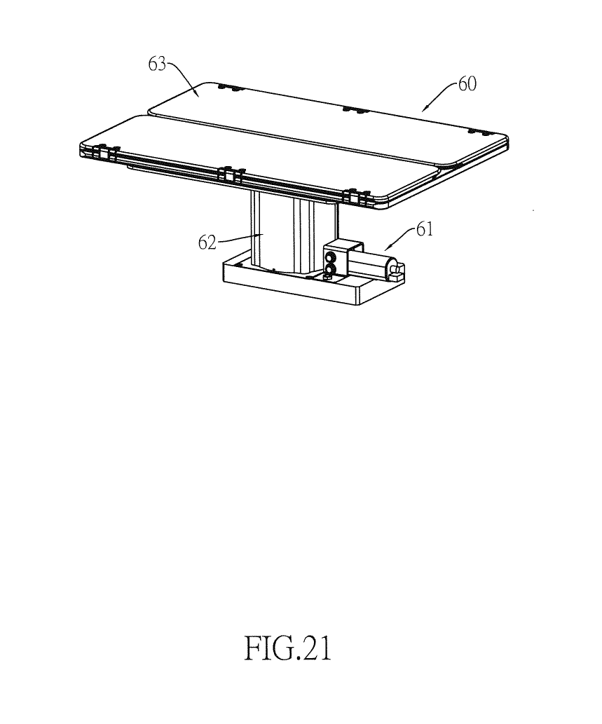

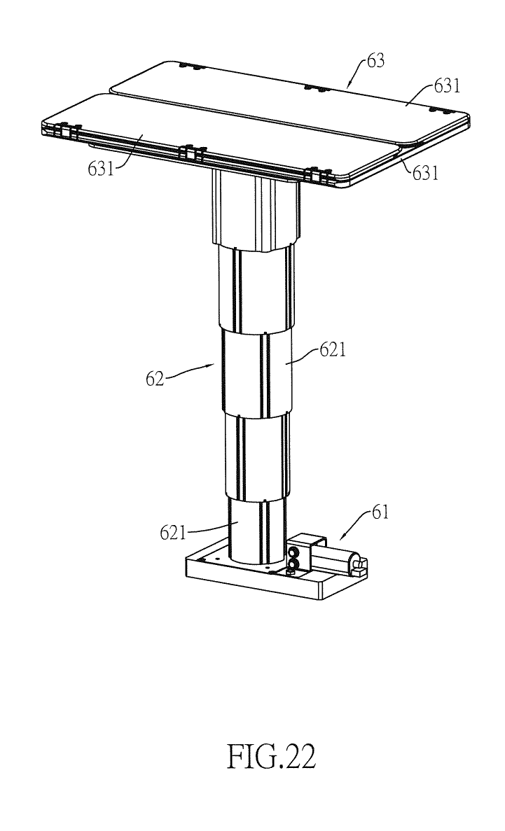

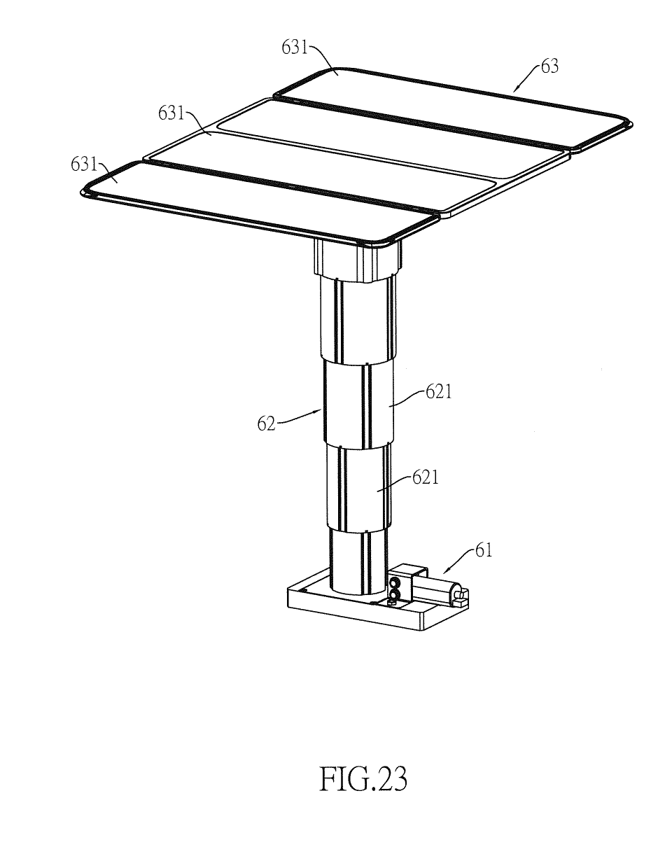

With reference to FIGS. 21 to 23, each elevatable desk 60 has a retractable rod 62, an actuating device 61 and a foldable desk panel 63. The retractable rod 62 is mounted in the main frame 50. The actuating device 61 is mounted in the main frame 50, and has components such as a motor and a gear assembly to extend the retractable rod 62 out of the main frame 50 or to retract the retractable rod 62 in the frame 50. In a preferred embodiment, the retractable rod 62 has multiple sleeves 621 sleeved around one another in sequence from the sleeve 621 of a bigger outer diameter to another sleeve 621 of a smaller outer diameter. The foldable desk panel 63 is mounted securely in an end of the retractable rod 62, and has multiple panel bodies 631 pivotally connected to each other. When not in use, the panel bodies 631 are folded to minimize the volume. When in use, the panel bodies 631 are rotated to extend the foldable desk panel 63. In a preferred embodiment, the foldable desk panel 63 has three panel bodies 631, one of the three panel bodies 631 is disposed in the middle, and the other two panel bodies 631 are respectively and pivotally connected to two sides of the panel body 63 that is disposed in the middle.

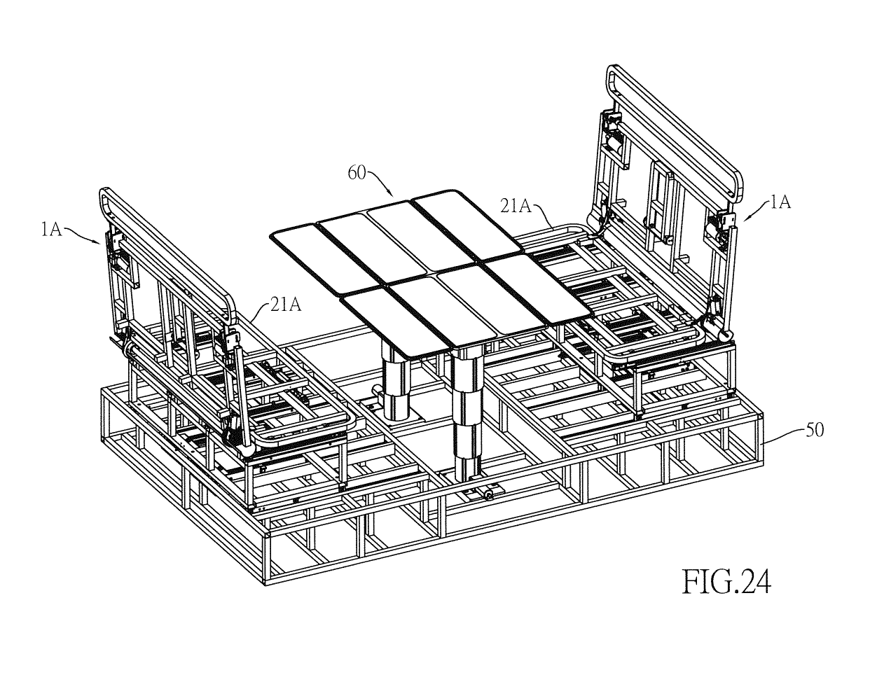

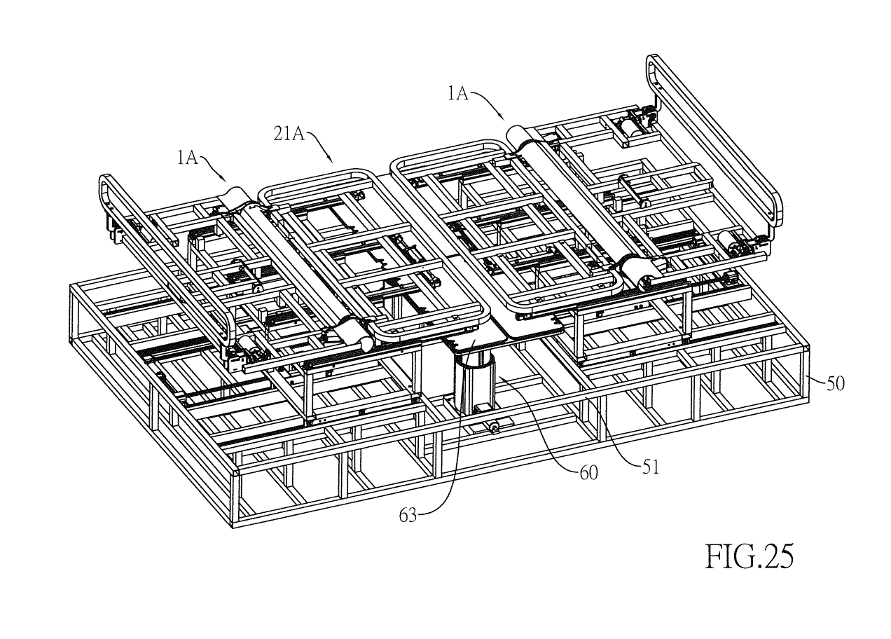

With reference to FIGS. 20, 24 and 25, when in use, the rotatable vehicle seat frame 1A is adjusted as mentioned above, such as starting the angle-adjusting mechanism 32A to adjust the angle of the back support bracket 31A, starting the sliding eccentric rod mechanism 42A to adjust the angle of the headrest bracket 41A, or fully retracting the elevatable desk 60 in the main frame 50 and simultaneously aligning the foldable desk panel 63 with a top surface 51 of the main frame 50, to be convenient for the user to walk on or stand on the foldable desk panel 63 as shown in FIG. 20. The elevatable desk 60 may be elevated when needed for the user who sits on the rotatable vehicle seat frame IA as shown in FIG. 24. Or the rotatable vehicle seat frame 1A may be rotated into the flattened status for use as bed, and the elevatable desk 60 is elevated to a height that makes the foldable desk panel 63 accurately abut the seat bracket 21 A to support the weight of the user lying down on the rotatable vehicle seat frame 1A, thereby reducing the shake of the seat bracket 21A, and distributing the force applied by the weight to prevent the rotatable vehicle seat frame 1A from breaking as shown in FIG. 25. Each of the two rotatable vehicle seat frames 1A disposed opposite to each other may be adjusted alone to meet the demands of the user.

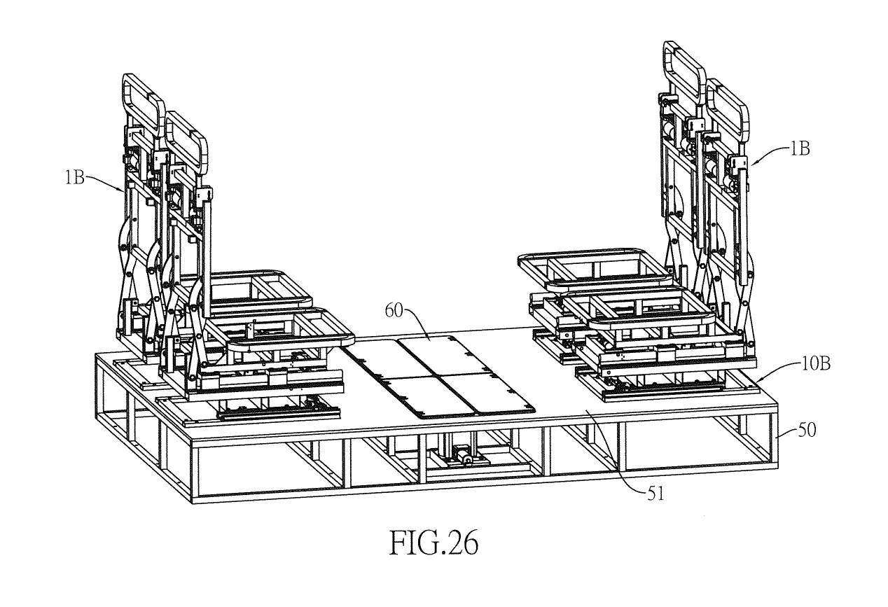

With reference to FIG. 26, a second embodiment of the rotatable vehicle seat frame assembly in accordance with the present invention is substantially similar to the first embodiment mentioned above. But the second embodiment has four rotatable vehicle seat frames 1B of the third embodiment mentioned above. Each rotatable vehicle seat frame 1B is for one passenger. The four rotatable vehicle seat frames 1B are disposed on the top surface 51 of the main frame 50 in two pairs. The two pairs of the rotatable vehicle seat frames 1B are disposed side by side, and the two rotatable vehicle seat frames 1B of each pair are disposed opposite to each other. The elevatable desks 60 are disposed between the pairs of the rotatable vehicle seat frames 1B, and are disposed side by side.

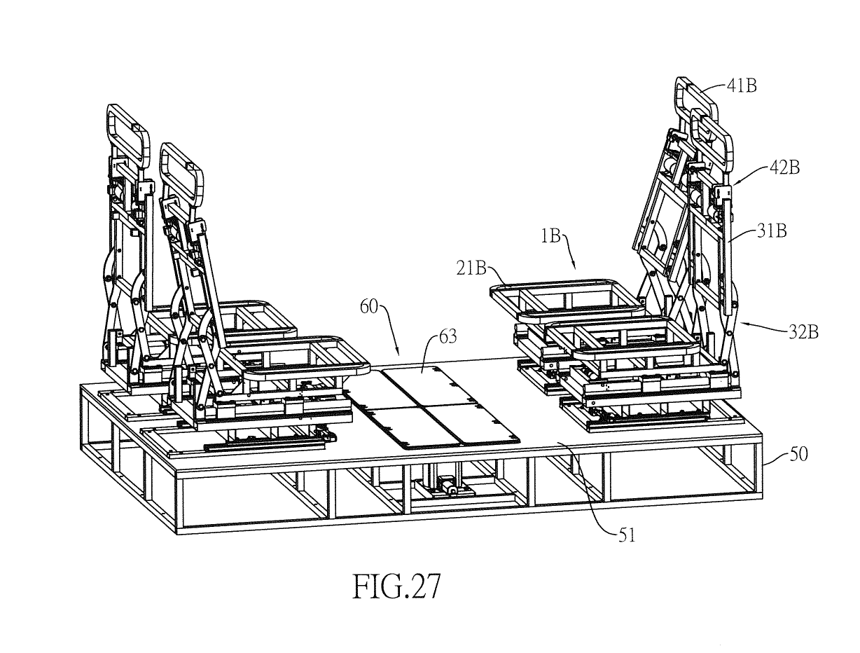

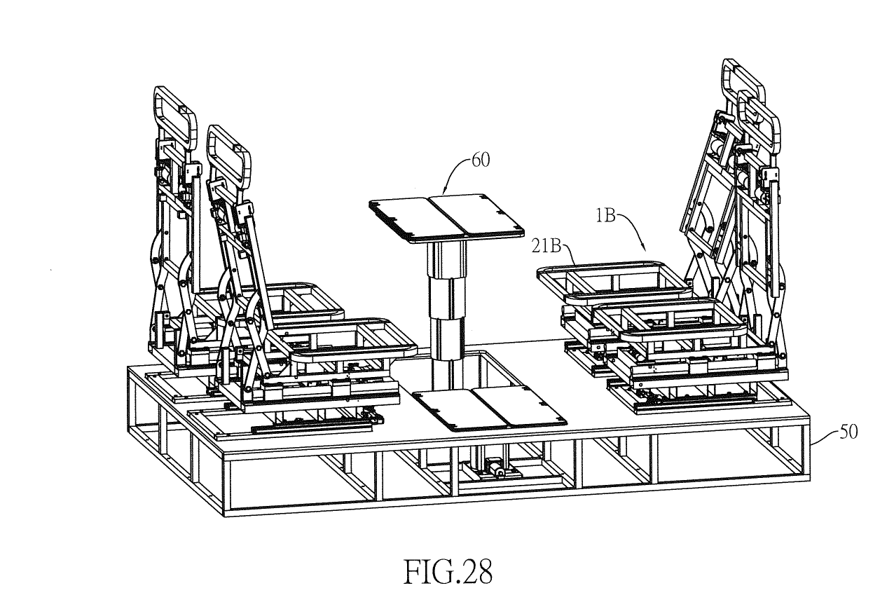

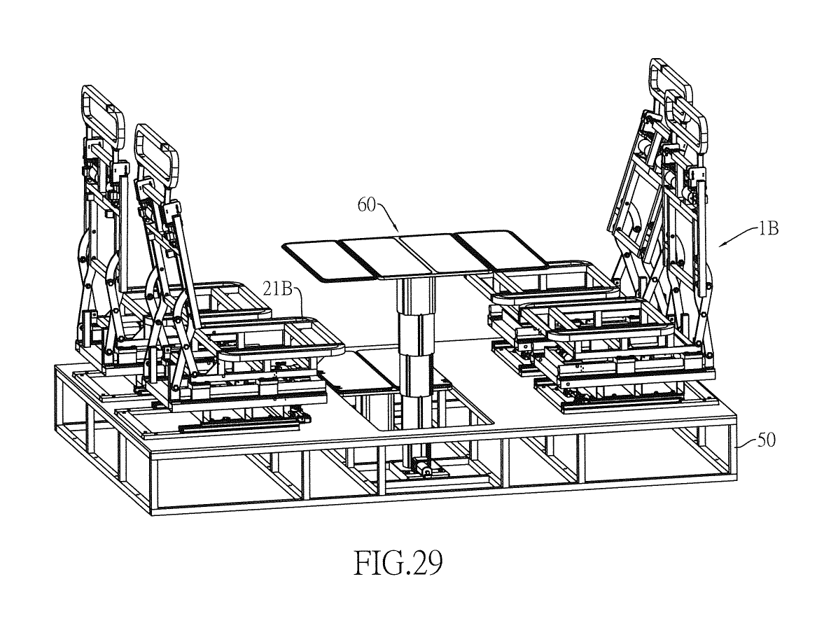

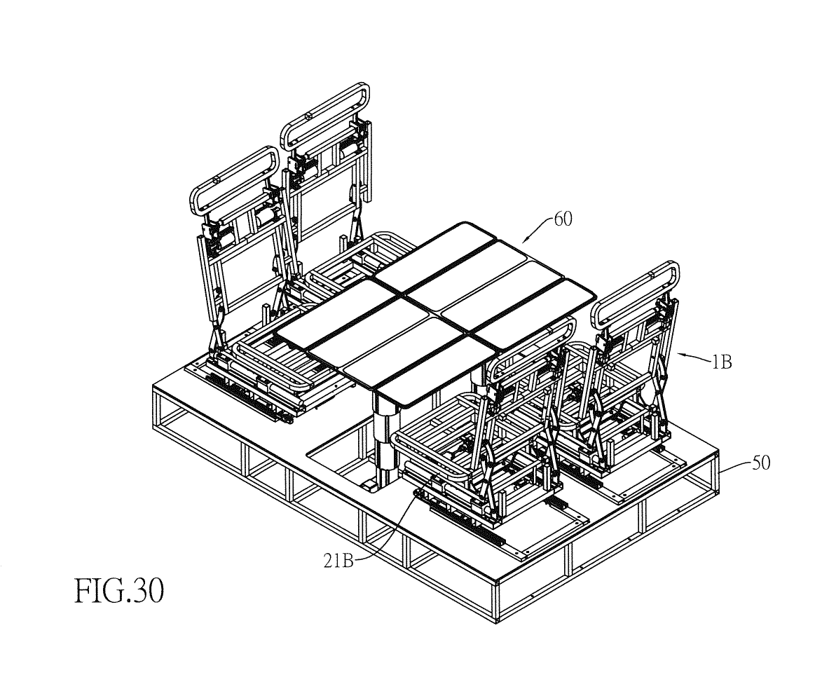

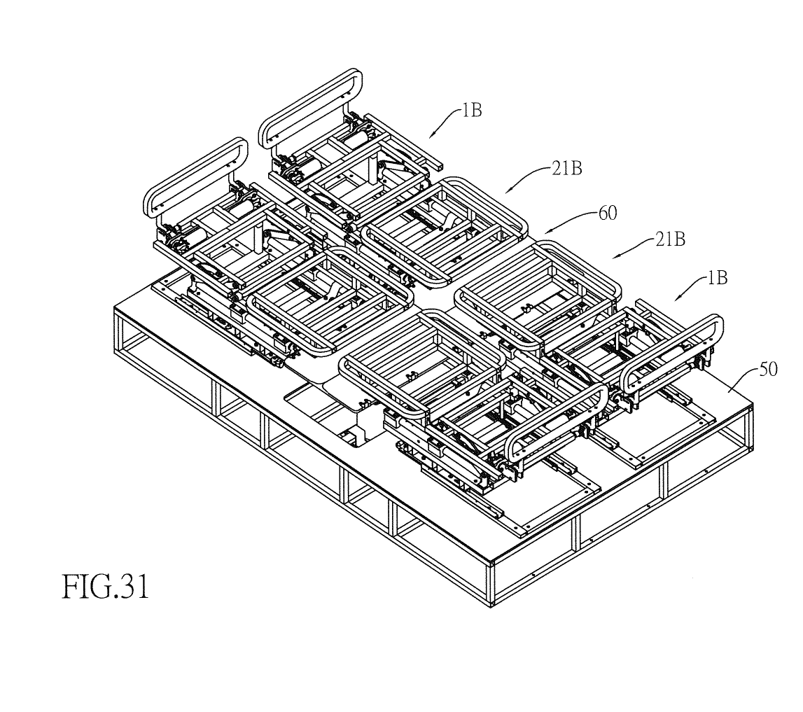

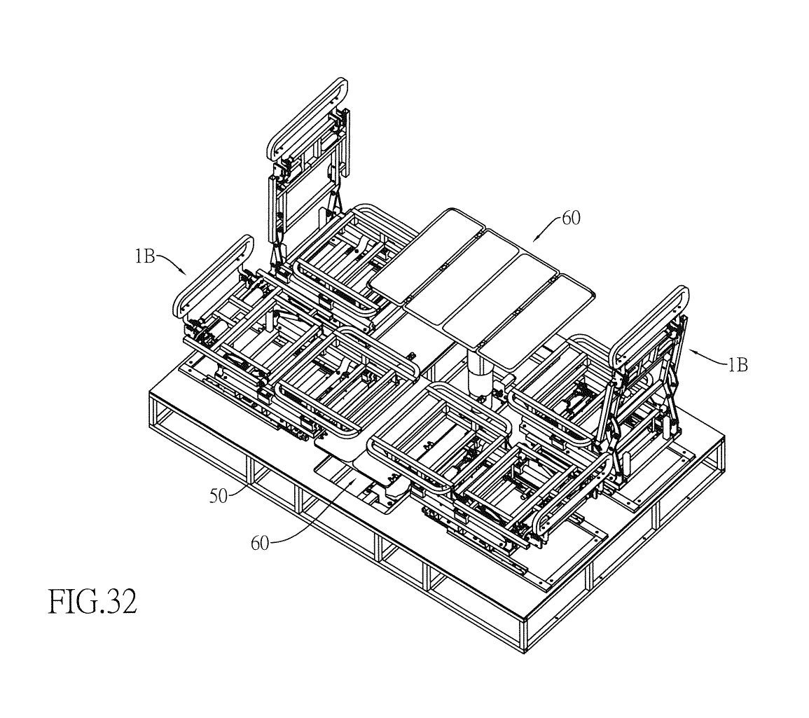

With reference to FIGS. 27 to 32, when in use, as the second embodiment has four separate rotatable vehicle seat frames 1B, each rotatable vehicle seat frame 1B may be adjusted alone as mentioned above to facilitate convenience in use. For example, starting the angle-adjusting mechanism 32B to adjust the angle of the back support bracket 31B, starting the sliding eccentric rod mechanism 42B to adjust the angle of the headrest bracket 41B as shown in FIG. 27, or fully retracting the elevatable desk 60 in the main frame 50 and simultaneously aligning the foldable desk panel 63 with the top surface 51 of the main frame 50, to be convenient for the user to walk on or stand on the foldable desk panel 63 as shown in FIG. 27. the elevatable desks 60 may be elevated all together or each individually when needed for part of or all the users who are seated on the rotatable vehicle seat frame 1B as shown in FIGS. 28 to 30. All the rotatable vehicle seat frames 1B may be rotated into the flattened status for use as bed, and the elevatable desks 60 are elevated to support the seat bracket 21B of the seat frames 1B as shown in FIG. 31. Or only one pair of the rotatable vehicle seat frames 1B are rotated into the flattened status to be connected with each other to form a bed, and the other pair of the rotatable vehicle seat frames 1B remain upright as shown in FIG. 32. At this time, the elevatable desk 60 between the flattened rotatable vehicle seat frames 1B is elevated to support the flattened seat frames 1B, and the elevatable desk 60 between the upright rotatable vehicle seat frames 1B is elevated higher to be used.

To sum up, the bottom sliding mechanism 13, the top sliding mechanism 22 and the angle-adjusting mechanism 32 enable the seat frame to be rotated into the flattened status in a limited inner space of a vehicle, and can hold the seat frame at any angle during the adjustment to facilitate convenience in use. The rotatable vehicle seat frame assembly, which further has the main frame 50 and the elevatable desk 60, may be applied in bigger vehicles, and provides more varieties in use and operation.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A rotatable vehicle seat frame comprising:
a stand assembly having
a base bracket;
a stand: and
a bottom sliding mechanism mounted between the base bracket and the stand to make the stand slidable relative to the base bracket;
a seat assembly slidably mounted on a top surface of the stand assembly, and having
a seat bracket; and
a top sliding mechanism mounted between the seat bracket and the stand to make the seat bracket slidable relative to the stand; and
a back support assembly pivotally connected to the seat assembly, and having
a back support bracket; and
at least one angle-adjusting mechanism mounted between the back support bracket and the seat bracket to make the back support bracket rotatable relative to the seat bracket.

2. The rotatable vehicle seat frame as claimed in claim 1 further comprising a headrest assembly pivotally connected to the back support assembly, and the headrest assembly having
a headrest bracket; and
at least one sliding eccentric rod mechanism mounted between the headrest bracket and the back support bracket to make the headrest bracket rotatable relative to the back support bracket.

3. The rotatable vehicle seat frame as claimed in claim 1, wherein
the stand assembly further has
at least one first channel assembly mounted on a top surface of the base bracket, and each one of the at least one first channel assembly having
a channel disposed on the top surface of the base bracket; and
a nut mounted in the channel of the first channel assembly; and
the bottom sliding mechanism of the stand assembly is mounted on a bottom surface of the stand, and has
at least one gear assembly;
a motor mounted securely on the bottom surface of the stand, and having
at least one drive shaft protruding out of an end of the motor of the bottom sliding mechanism, and mounted in the at least one gear assembly of the bottom sliding mechanism; and
at least one threaded rod; each one of the at least one threaded rod of the bottom sliding mechanism having
a first end screwed into the gear assembly of the bottom sliding mechanism; and
a second end screwed into the nut of the first channel assembly.

4. The rotatable vehicle seat frame as claimed in claim 3, wherein
the motor of the bottom sliding mechanism is disposed in a center of the stand;
a number of the at least one first channel assembly of the stand assembly is plural; the first channel assemblies are arranged apart from each other;
a number of the at least one drive shaft of the motor of the bottom sliding mechanism is two;
a number of the at least one gear assembly of the bottom sliding mechanism is plural;
a number of the at least one threaded rod of the bottom sliding mechanism is plural; and
the drive shafts of the motor of the bottom sliding mechanism respectively protrude out of two ends of said motor, and respectively actuate the gear assemblies and the threaded rods of the bottom sliding mechanism.

5. The rotatable vehicle seat frame as claimed in claim 1, wherein
the stand assembly further has
at least one second channel assembly mounted on a top surface of the stand, and each one of the at least one second channel assembly having
a channel disposed on the top surface of the stand; and
a nut mounted in the channel of the second channel assembly; and
the top sliding mechanism of the seat assembly is mounted on a bottom surface of the seat bracket, and has
at least one gear assembly;
a motor mounted securely on the bottom surface of the seat bracket, and having
at least one drive shaft protruding out of an end of the motor of the top sliding mechanism, and mounted in the at least one gear assembly of the top sliding mechanism; and
at least one threaded rod; each one of the at least one threaded rod of the top sliding mechanism having
a first end screwed into the gear assembly of the top sliding mechanism; and
a second end screwed into the nut of the second channel assembly.

6. The rotatable vehicle seat frame as claimed in claim 5, wherein
the motor of the top sliding mechanism is disposed in a center of the seat bracket;
a number of the at least one second channel assembly of the stand assembly is plural; the second channel assemblies are arranged apart from each other;
a number of the at least one drive shaft of the motor of the top sliding mechanism is two;
a number of the at least one gear assembly of the top sliding mechanism is plural;
a number of the at least one threaded rod of the top sliding mechanism is plural; and
the drive shafts of the motor of the top sliding mechanism respectively protrude out of two ends of said motor, and respectively actuate the gear assemblies and the threaded rods of the top sliding mechanism.

7. The rotatable vehicle seat frame as claimed in claim 1, wherein
the seat assembly further has
at least one pivot seat formed on a back side of the seat bracket;
the back support assembly further has
at least one pivot seat formed on a bottom side of the back support bracket; and
each of the at least one angle-adjusting mechanism of the back support assembly has
at least one motor assembly mounted securely on the back support bracket and having
an output shaft engaging with the corresponding pivot seat of the seat assembly.

8. The rotatable vehicle seat frame as claimed in claim 7, wherein
the at least one motor assembly of each of the at least one angle-adjusting mechanism of the back support assembly has
an actuating assembly connected to the corresponding pivot seat of the seat assembly; and
a driven gear connected to the actuating assembly; and
the back support assembly has
a pintle mounted through the at least one pivot seat of the seat assembly and the at least one pivot seat of the back support assembly, and mounted in and rotated by the at least one motor assembly of the at least one angle-adjusting mechanism; and
at least one driving gear mounted around the pintle, and engaging with the driven gear of the corresponding angle-adjusting mechanism.

9. The rotatable vehicle seat frame as claimed in claim 8, wherein
a number of the at least one angle-adjusting mechanism of the back support assembly is two, and the angle-adjusting mechanisms are disposed in two sides of the back support bracket;
a number of the at least one pivot seat of the seat assembly is two, and the pivot seats of the seat assembly are disposed in two sides of the seat bracket; and
a number of the at least one pivot seat of the back support assembly is two, and the pivot seats of the back support assembly are disposed in two sides of the back support bracket.

10. The rotatable vehicle seat frame as claimed in claim 7, wherein
a number of the at least one motor assembly of each angle-adjusting mechanism is two.

11. The rotatable vehicle seat frame as claimed in claim 7, wherein
a number of the at least one motor assembly of each angle-adjusting mechanism is one.

12. The rotatable vehicle seat frame as claimed in claim 1, wherein each angle-adjusting mechanism of the back support assembly has
a first rod having
a first end pivotally connected to the stand;
a second end pivotally connected to the back support bracket; and
a center segment;
a second rod having
a first end pivotally connected to the seat bracket;
a second end; and
a center segment pivotally connected to the center segment of the first rod; and
a third rod having
a first end pivotally connected to the second end of the second rod; and
a second end pivotally connected to the back support bracket.

13. The rotatable vehicle seat frame as claimed in claim 2, wherein
the back support bracket has
at least one recess formed in the back support bracket; and
each one of the at least one sliding eccentric rod mechanism has
a motor assembly mounted in the recess of the back support bracket;
a threaded rod rotated by the motor assembly of the sliding eccentric rod mechanism;
a nut mounted around the threaded rod of the sliding eccentric rod mechanism;
a swing arm mounted securely on a bottom side of the headrest bracket;
a positioning rotating shaft transversely mounted through and pivotally connected to the swing arm; and
a connecting arm having
a first end pivotally connected to the nut of the sliding eccentric rod mechanism;
a second end pivotally connected to the swing arm of the sliding eccentric rod mechanism; and
a side abutting the positioning rotating shaft.

14. The rotatable vehicle seat frame as claimed in claim 13, wherein
the sliding eccentric rod mechanism further has
a limit pin disposed in a side of the positioning rotating shaft; and
the swing arm of the sliding eccentric rod mechanism has
a stop protrusion formed on an end of the swing arm and selectively abutting the limit pin.

15. A rotatable vehicle seat frame assembly having multiple rotatable vehicle seat frames as claimed in claim 1, the rotatable vehicle seat frame assembly comprising:
a main frame; and
at least one elevatable desk retractably mounted in the main frame;
wherein the stand assembly of each rotatable vehicle seat frame is mounted on the main frame.

16. The rotatable vehicle seat frame assembly as claimed in claim 15, wherein each one of the at least one elevatable desk has
a retractable rod mounted in the main frame;
an actuating device mounted in the main frame, and extending or retracting the retractable rod; and
a foldable desk panel mounted securely in an end of the retractable rod.

17. The rotatable vehicle seat frame assembly as claimed in claim 16, wherein the retractable rod has
multiple sleeves sleeved around one another in sequence from the sleeve of a bigger outer diameter to the sleeve of a smaller outer diameter.

18. The rotatable vehicle seat frame assembly as claimed in claim 16, wherein the foldable desk panel has
multiple panel bodies pivotally connected to each other.

19. The rotatable vehicle seat frame assembly as claimed in claim 15, wherein
a number of the rotatable vehicle seat frames is two; the two rotatable vehicle seat frames are disposed on a top surface of the main frame and disposed opposite to each other; and
a number of the at least one elevatable desk is two; the two elevatable desks are disposed between the rotatable vehicle seat frames and disposed side by side.

20. The rotatable vehicle seat frame assembly as claimed in claim 15, wherein
a number of the rotatable vehicle seat frames is four; the four rotatable vehicle seat frames are disposed on a top surface of the main frame in two pairs; the two pairs of the rotatable vehicle seat frames are disposed side by side, and the two rotatable vehicle seat frames of each pair are disposed opposite to each other; and
a number of the at least one elevatable desk is two; the two elevatable desks are disposed between the pairs of the rotatable vehicle seat frames and disposed side by side.
